(19) United States
(12) Patent Application Publication
(10) Pub. No.: US 2008/0287008 A1
(43) Pub. Date: Nov. 20, 2008

(54) Electronic device having molded resin case, and molding tool and method of manufacturing the same

(75) Inventors: Tatsuya Watanabe, Anjo-city (JP); Masahiko Imoto, Kariya-city (JP); Yoshinari Goshima, Toyohashi-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/152,206

(22) Filed: May 13, 2008

(30) Foreign Application Priority Data
May 18, 2007 (JP) 2007-133190

(51) Int. Cl. H01R 13/66; B29C 70/72

(52) U.S. Cl. 439/620.25; 264/241; 425/110

(57) ABSTRACT

An electronic device includes an electronic circuit section, a case, and a connector housing. The electronic circuit section includes a connector terminal. The case seals the electronic circuit section in such a manner that the connector terminal protrudes to an outside of the case. The connector housing is integrated with the case and has an approximately cylindrical shape to surround an outer circumference of the connector terminal. The case and the connector housing are made of resin with a molding tool by filling resin into a case cavity and a connector-housing cavity of the molding tool in a state where the electronic circuit section is held by a holding portion of the molding tool.

### CROSS REFERENCE TO RELATED APPLICATION

This application is based on Japanese Patent Application No. 2007-133190 filed on May 18, 2007, the contents of which are incorporated herein by reference in its entirety.

### BACKGROUND OF THE INVENTION

1. Field of the Invention

The present invention relates to an electronic device having an electronic circuit section and a molded resin case that seals the electronic circuit section. The present invention also relates to a molding tool and a method of manufacturing the electronic device.

2. Description of the Related Art

JP-5-21492A discloses a hybrid integrated circuit (hybrid IC) that includes a hybrid IC substrate having a lead wire and a resin film for sealing the hybrid IC substrate. The resin film is formed by using a molding tool. The molding tool includes an upper molding section and a lower molding section. The lower molding section has a plurality of holding members that protrudes from a lower portion of the lower molding section to a molding space. The holding members are provided to be movable in an up-and-down direction. The hybrid IC substrate is disposed on the holding members protruding to the molding space in a state where the lead wire is inserted in a receiving groove. Melting resin is filled into the molding space through a supplying passage and a submarine gate. When melting resin of in a range from about 90 weight % to about 95 weight % of a final filling amount (i.e., most of melting resin) is filled into the molding space, the holding member moves downward. Then, melting resin is further filled into the molding space while adding a predetermined pressure. Thereby, the resin film that seals the hybrid IC substrate is formed.

When melting resin is filled into the molding space, the hybrid IC substrate is applied with a filling pressure. The hybrid IC substrate is held by the holding members and is prevented from displacing or inclining until most of melting resin is filled into the molding space. However, melting resin is further filled into the molding space in a state where the holding members moves downward. Thus, even through the hybrid IC substrate is held until most of melting resin is filled, it is difficult to prevent the hybrid IC substrate from displacing or inclining sufficiently. For example, in a case where a sensor element for detecting a physical quantity in a predetermined direction is mounted on the hybrid IC substrate, the sensor element may be difficult to detect the physical quantity with a high degree of accuracy when the hybrid IC substrate is displaced or inclined.

Alternatively, the holding member may be prevented from moving downward until melting resin is cooled and solidified completely. In the present case, a plurality of through holes extending to the hybrid IC substrate may be provided at the resin film by the holding members. Thus, an additional process for sealing the through holes is required to ensure a waterproof property.

### SUMMARY OF THE INVENTION

In view of the foregoing problems, it is a first object of the present invention to provide an electronic device having a molded resin case. A second object of the invention is to provide a molding tool of manufacturing the electronic device, and a third object of the invention is to provide a method of manufacturing the electronic device.

According to a first aspect of the invention, an electronic device includes an electronic circuit section, a case, and a connector housing. The electronic circuit section includes a connector terminal. The case seals the electronic circuit section in such a manner that the connector terminal protrudes to an outside of the case. The connector housing is integrated with the case and has an approximately cylindrical shape to surround an outer circumference of the connector terminal. The case and the connector housing are made of resin with a molding tool that includes a case cavity, a connector-housing cavity, and a holding portion, by filling resin into the case cavity and the connector-housing cavity in a state where the electronic circuit section is held by the holding portion. The connector-housing cavity has the approximately cylindrical shape and one end portion of the connector-housing cavity is communicated with the case cavity. The holding portion protrudes to the case cavity from a portion of an inner surface that defines the case cavity and that is partitioned by the connector-housing cavity.

According to a second aspect of the invention, a molding tool of manufacturing an electronic device includes a case cavity, a connector-housing cavity, a holding portion, and a supplying passage. The electronic device includes an electronic circuit section, a case, and a connector housing, in which the electronic circuit section includes a connector terminal, the case seals the electronic circuit section in such a manner that the connector terminal protrudes to an outside of the case, and the connector housing is integrated with the case and has an approximately cylindrical shape to surround an outer circumference of the connector terminal. The case cavity is configured to house an electronic circuit section and to provide the case. The connector-housing cavity has the approximately cylindrical shape to provide the connector housing, and one end portion of the connector-housing cavity is communicated with the case cavity. The holding portion protrudes to the case cavity from a portion of an inner surface, in which the portion of the inner surface defines the case cavity and is partitioned by the connector-housing cavity. The supplying passage is configured to introduce resin to the case cavity and the connector-housing cavity.

According to a third aspect of the invention, a method of manufacturing an electronic device, includes: preparing a molding tool that includes a case cavity, a connector-housing cavity, and a holding portion, in which the connector-housing cavity has an approximately cylindrical shape and one end portion of the connector-housing cavity is communicated with the case cavity, and the holding portion protrudes to the case cavity from a portion of an inner surface that defines the case cavity and that is partitioned by the connector-housing cavity; disposing an electronic circuit section having a connector terminal in the case cavity in such a manner that the electronic circuit section is held by the holding portion; and filling melting resin into the case cavity and the connector-housing cavity and solidifying the melting resin so as to form a case that seals the electronic circuit section in such a manner that the connector terminal protrudes to an outside of the case and a connector housing that surrounds an outer circumference of the connector terminal.

In the above-described electronic device, molding tool, and manufacturing method, the electronic circuit section can be held by the holding portion from when resin is filled into the case cavity and the connector-housing cavity till when the resin is cooled and solidified. Thus, even when the electronic circuit section is applied with a filling pressure, the electronic circuit section is prevented from displacing or inclining from a predetermined position. When the electronic device is taken out from the molding tool, holes extending to the electronic circuit section are provided at the case by the holding portions. However, opening portions of the holes are surrounded by the connector housing, and a connector housing of an opposite element will be inserted into the connector housing of the electronic device. Thus, the electronic device can have a waterproof property without additional process for sealing the holes.

### BRIEF DESCRIPTION OF THE DRAWINGS

Additional objects and advantages of the present invention will be more readily apparent from the following detailed description of preferred embodiment when taken together with the accompanying drawings. In the drawings:

FIG. 1 is a cross-sectional view showing an acceleration sensor according to an embodiment of the invention;

FIG. 2 is a top view showing the acceleration sensor;

FIG. 3 is a front view showing the acceleration sensor;

FIG. 4 is a cross-sectional view showing a molding tool of manufacturing the acceleration sensor;

FIG. 5 is another cross-sectional view showing the molding tool taken along line V-V in FIG. 4; and

FIG. 6 is a cross-sectional view showing the molding tool in a state where resin is filled into the molding tool.

### DETAILED DESCRIPTION OF THE PREFERRED EMBODIMENT

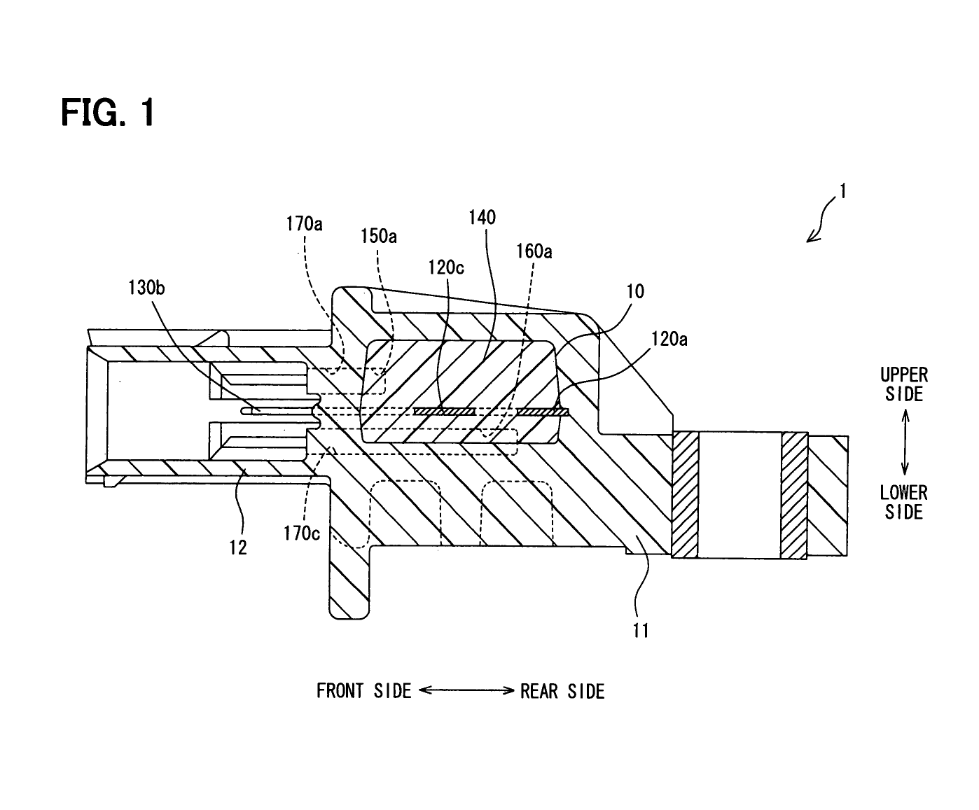

An electronic device according an embodiment of the invention can be suitably used for an acceleration sensor 1 for detecting an acceleration of a vehicle, for example. As shown in FIGS. 1-3, the acceleration sensor 1 includes an electronic circuit section 10, a case 11, and a connector housing 12. In FIGS. 1-3, directions of a front side, a rear side, an upper side, and a lower side are shown as a matter of convenience for describing a exemplary structure of the acceleration sensor 1.

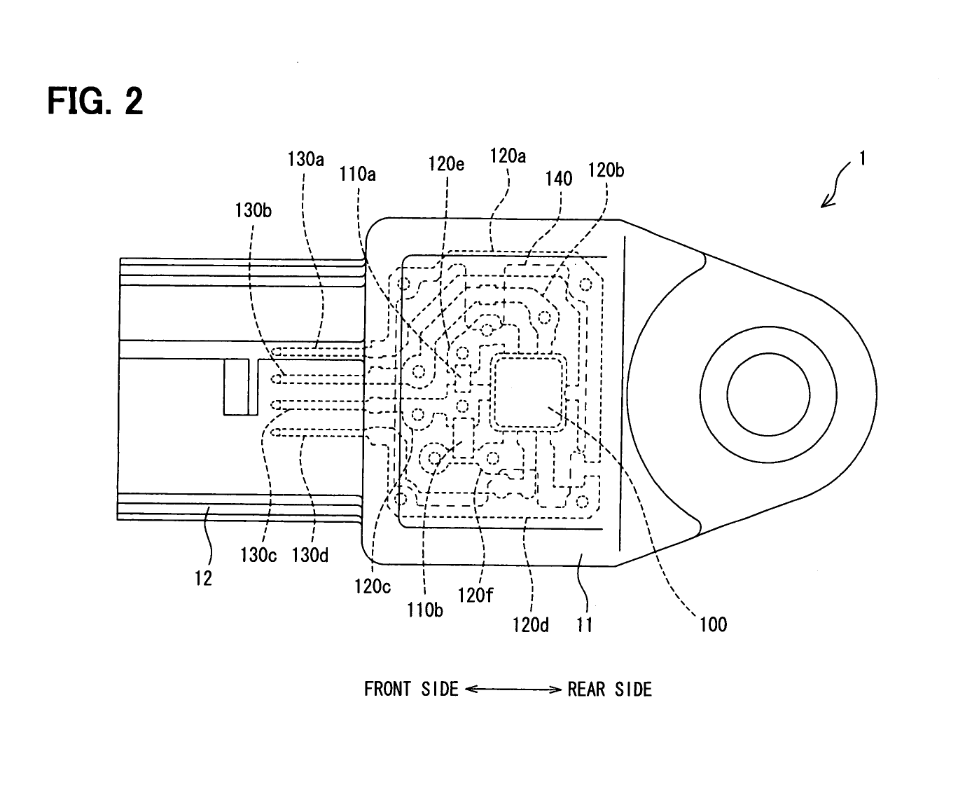

The electronic circuit section 10 is configured to detect acceleration in a predetermined direction and to output a signal in accordance with the detected acceleration. As shown in FIG. 2, the electronic circuit section 10 includes a sensor element 100, capacitors 110a and 110b, wiring plates 120a-120f (i.e., wiring member), connector terminals 130a-130d, and a sealing member 140.

The sensor element 100 is configured to detect acceleration in the predetermined direction and to output the signal in accordance with the detected acceleration. The capacitors 110a and 110b are configured to operate the sensor element 100. The wiring plates 120a-120f are made of metal and have predetermined shapes to wire the sensor element 100 and the capacitors 110a and 110b. The sensor element 100 is soldered with the wiring plates 120a-120f. The capacitor 110a is soldered with the wiring plates 120c and 120e, and the capacitor 110b is soldered with the wiring plates 120c and 120f.

The connector terminals 130a-130d are made of metal and have predetermined shapes to couple an electronic element that includes the sensor element 100 and the capacitors 110a and 110b with an external device. The connector terminals 130a-130d are integrally formed with the wiring plates 120a-120d respectively and are arranged at end portions of the wiring plates 120a-120d respectively.

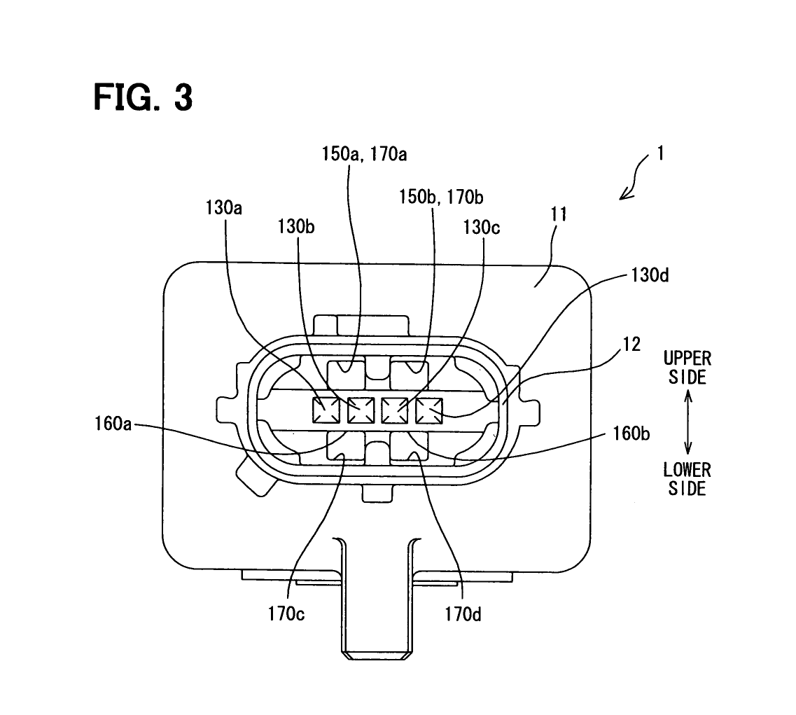

The sealing member 140 integrally seals the sensor element 100 and the capacitors 110a and 110b, which are wired by the wiring plates 120a-120f. The sealing member 140 is made of resin and is formed by using a molding tool. As shown in FIGS. 1 and 3, at a front portion of the sealing member 140, inserting holes 150a and 150b each having an approximately rectangular shape in cross section are provided to extend toward the rear side. At a lower portion of the sealing member 140, grooves 160a and 160b each having an approximately rectangular shape in cross section are provided to extend toward the rear side.

The case 11 seals the electronic circuit section 10 in such a manner that end portions of the connector terminals 130a-130d protrude from the case 11. The case 11 is made of resin and is independent from the sealing member 140. The connector housing 12 is made of resin integrally with the case 11 at a front end portion of the case 11. The connector housing 12 has an approximately cylindrical shape to surround an outer circumference of the protruding connector terminals 130a-130d. The case 11 and the connector housing 12 are formed by using a molding tool 2. As shown in FIG. 3, at the front end portion of the case 11 surrounded by the connector housing 12, holes 170a-170d are provided. The holes 170a-170d are provided by the holding portions 220a-220d of the molding tool 2 when the case 11 and the connector housing 12 are formed.

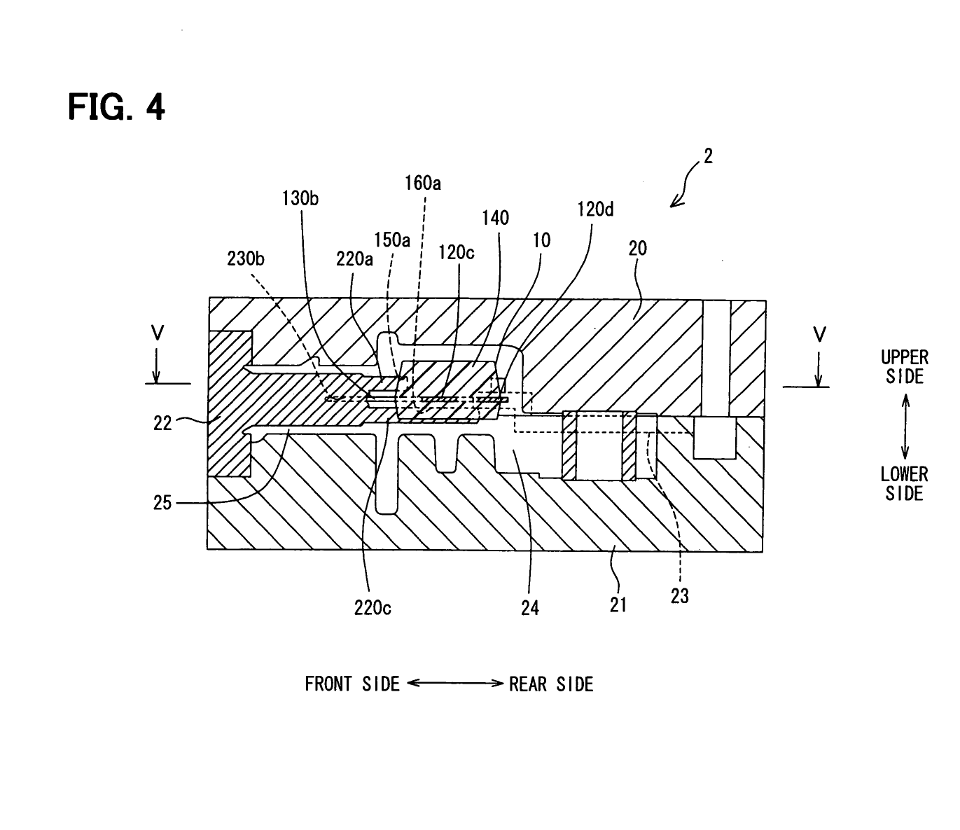

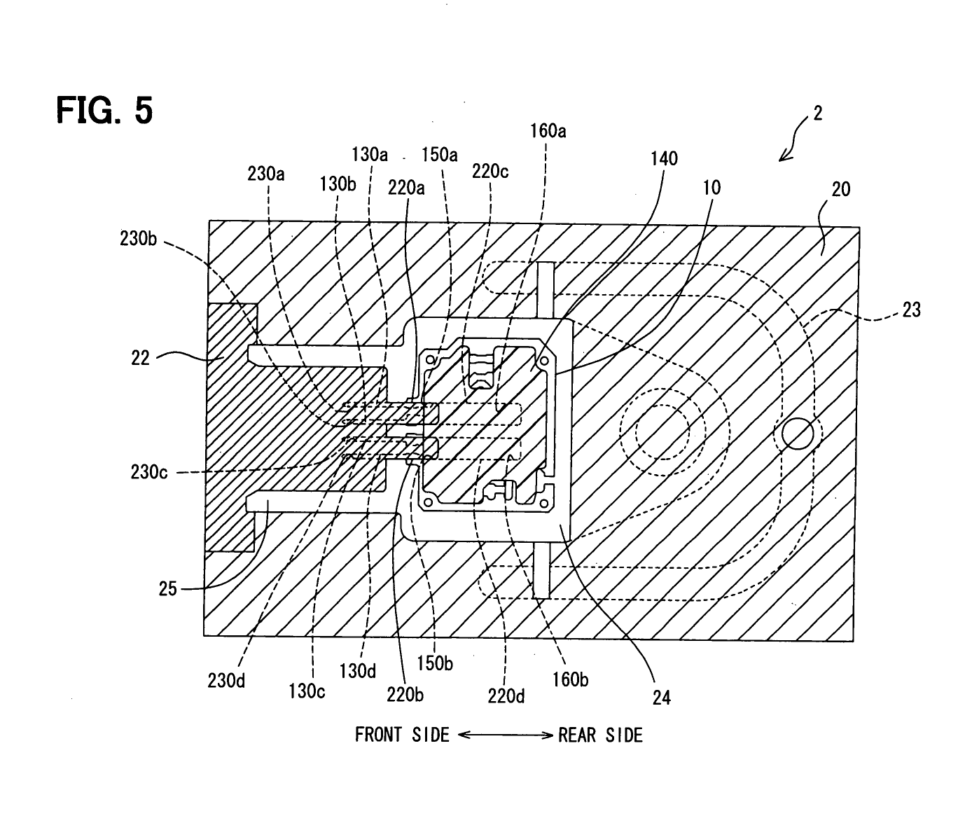

An exemplary structure of the molding tool 2 of manufacturing the case 11 and the connector housing 12, and a method of manufacturing the case 11 and the connector housing 12 will now be described with reference to FIGS. 4-6. In FIGS. 4-6, directions of a front side, a rear side, an upper side, and a lower side are shown as a matter of convenience for describing the structure of the molding tool 2.

The molding tool 2 includes an upper molding section 20, a lower molding section 21, a slide core 22, and a supplying passage 23.

The upper molding section 20 is configured to form upper portions of the case 11 and the connector housing 12. The lower molding section 21 is configured to form lower portions of the case 11 and the connector housing 12. The slide core 22 is configured to form the front end portion of the case 11 and an inner circumference of the connector housing 12. At a rear portion of the slide core 22, holding portions 220a-220d each having an approximately rectangular column shape are provided to extend toward the rear side. In addition, the rear portion of the slide core 22 has inserting holes 230a-230d extending toward the front side. When the case 11 and the connector housing 12 are formed with the molding tool 2, the holding portions 220a and 220b are respectively inserted into the inserting holes 150a and 150b of the sealing member 140, and the holding portions 220c and 220d are respectively engaged with the grooves 160a and 160b of the sealing member 140. Furthermore, the connector terminals 130a-130d are respectively inserted into the inserting holes 230a-230d of the slide core 22.

The upper molding section 20, the lower molding section 21, and the slide core 22 define the case cavity 24 at an approximately center portion thereof. The case cavity 24 is configured to house the electronic circuit section 10 therein and to provide the case 11. In addition, the upper molding section 20, the lower molding section 21, and the slide core 22 define a connector-housing cavity 25 on a front side of the case cavity 24. The connector-housing cavity 25 has an approximately cylindrical shape, and a rear end portion of connector-housing cavity 25 is communicated with the case cavity 24. The connector-housing cavity 25 is configured to form the connector housing 12. The holding portions 220a-220d protrude from a portion of an inner surface of the molding tool 2 that defines the case cavity 24 and that is partitioned with the connector-housing cavity 25. That is, the holding portions 220a-220d protrude from the rear surface of the slide core 22. Furthermore, the upper molding section 20 and the lower molding section defines supplying passage 23 for introducing melting resin 3 from an outside of the molding tool 2 to the case cavity 24 and the connector-housing cavity 25. One end portion of the supplying passage 23 opens on an upper surface of the upper molding section 20. The other end portions of the supplying passage 23 open on both inner side surfaces of the molding tool 2 that define the case cavity 24.

The connector terminals 130a-130d are respectively inserted into the inserting holes 230a-230d of the slide core 22, and thereby the electronic circuit section 10 is positioned in the case cavity 24. Furthermore, the holding portions 220a and 220b are respectively inserted into the inserting holes 150a and 150b of the electronic circuit section 10, and the holding portions 220c and 220d are respectively engaged with the grooves 160a and 160b. Thereby, the electronic circuit section 10 is held by the slide core 22.

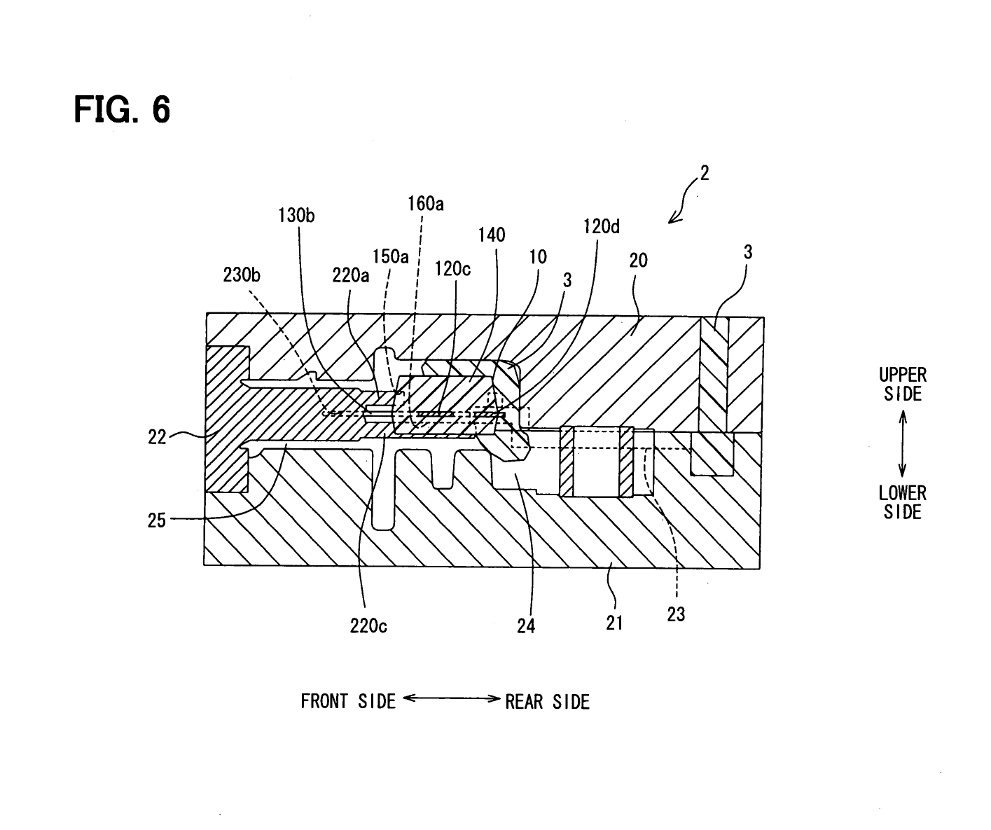

After the electronic circuit section 10 is housed in the molding tool 2, melting resin 3 is filled into the case cavity 24 through the supplying passage 23, as shown in FIG. 6. In addition, melting resin 3 is filled into the connector-housing cavity 25 through the case cavity 24. The electronic circuit section 10 is applied with a filling pressure when melting resin 3 is filled into the case cavity 24. However, the electronic circuit section 10 is held by the holding portions 220a-220d until the melting resin 3 is cooled and solidified. Thus, the electronic circuit section 10 is prevented from displacing or inclining from a predetermined position. Thus, the electronic circuit section 10 can detect acceleration in the predetermined direction with a high degree of certainty.

When the acceleration sensor 1 is taken out from the molding tool 2, the holes 170a-170d are provided at the case 11 by the holding portions 220a-220d respectively, as shown FIG. 3. However, opening portions of the holes 170a-170d are surrounded by the connector housing 12. Furthermore, a connector housing of the external device (i.e., opposing element) will be inserted into the connector housing 12. Thus, the acceleration sensor 1 has a waterproof property without additional process for sealing the holes 170a-170d.

In the above-described embodiment, the molding tool 2 can hold the sealing member 140 of the electronic circuit section 10 using the holding portions 220a-220d from when melting resin 3 is filled into the molding tool 2 till when the melting resin 3 is cooled and solidified. Thus, even when the electronic circuit section 10 is applied with the filling pressure, the electronic circuit section 10 is prevented from displacing or inclining from the predetermined position. When the acceleration sensor 1 is taken out from the molding tool 2, the holes 170a-170d are provided at the case 11 by the holding portions 220a-220d, respectively. However, the opening portions of the holes 170a-170d are surrounded by the connector housing 12, and the connector housing of the external device will be inserted into the connector housing 12. Thus, the acceleration sensor 1 has the waterproof property without additional process for sealing the holes 170a-170d.

The connector terminals 130a-130d are integrally formed with the wiring plates 120a-120d respectively, and are arranged at the end portions of the wiring plates 120a-120d respectively. Thus, the number of components can be reduced.

Furthermore, the electronic circuit section 10 has the sealing member 140 that integrally seals the electronic element including the sensor element 100 and the capacitors 110a and 110b. The sealing member 140 is made of resin and is independent from the case 11 and the connector housing 12. When resin that forms the case 11 and the connector housing 12 directly seals the electronic element, soldering portions between the electronic element and the wiring plates 120a-120f may be applied with a thermal stress or a pressure. However, when the electronic element is sealed with the sealing member 140 that is independent from the case 11 and the connector housing 12, effects of the thermal stress and the pressure can be reduced.

In the above-described embodiment, the electronic circuit section 10 includes the sensor element 100, the capacitors 110a and 110b, the wiring plates 120a-120f, the connector terminals 130a-130, and the sealing member 140, as examples. Alternatively, the electronic circuit section 10 may have other components. For example, a printed wiring board may be used as a wiring member instead of the wiring plates 120a-120f. The sealing member 140 is not always required.

Such changes and modifications are to be understood as being within the scope of the present invention as defined by the appended claims.

What is claimed is:

1. An electronic device comprising:
an electronic circuit section that includes a connector terminal;
a case that seals the electronic circuit section in such a manner that the connector terminal protrudes to an outside of the case; and
a connector housing that is integrated with the case and that has an approximately cylindrical shape to surround an outer circumference of the connector terminal, wherein:
the case and the connector housing are made of resin with a molding tool that includes a case cavity, a connector-housing cavity, and a holding portion, by filling resin into the case cavity and the connector-housing cavity in a state where the electronic circuit section is held by the holding portion;
the connector-housing cavity has the approximately cylindrical shape and one end portion of the connector-housing cavity is communicated with the case cavity; and
the holding portion protrudes to the case cavity from a portion of an inner surface that defines the case cavity and that is partitioned by the connector-housing cavity.

2. The electronic device according to claim 1, wherein:
the electronic circuit section further includes an electronic element and a wiring member that is configured to wire the electronic element; and
the connector terminal is electrically coupled with the wiring member.

3. The electronic device according to claim 2, wherein
the wiring member is made of a metal plate and is integrated with the connector terminal.

4. The electronic device according to claim 2, wherein:
the electronic circuit section further includes a sealing member that seals the electronic element;
the sealing member is made of resin and is independent from the case and the connector housing; and
the sealing member is configured to be held by the holding portion when the case and the connector housing are made.

5. A molding tool of manufacturing an electronic device including an electronic circuit section that includes a connector terminal, a case that seals the electronic circuit section in such a manner that the connector terminal protrudes to an outside of the case, and a connector housing that is integrated with the case and that has an approximately cylindrical shape to surround an outer circumference of the connector terminal, the molding tool comprising:
a case cavity that is configured to house the electronic circuit section and to provide the case;
a connector-housing cavity that has the approximately cylindrical shape to provide the connector housing, wherein one end portion of the connector-housing cavity is communicated with the case cavity;
a holding portion that protrudes to the case cavity from a portion of an inner surface, wherein the portion of the inner surface defines the case cavity and is partitioned by the connector-housing cavity; and
a supplying passage configured to introduce resin to the case cavity and the connector-housing cavity.

6. The molding tool according to claim 5, wherein
the holding portion includes a plurality of holding elements.

7. A method of manufacturing an electronic device, comprising:
preparing a molding tool that includes a case cavity, a connector-housing cavity, and a holding portion, wherein the connector-housing cavity has an approximately cylindrical shape and one end portion of the connector-housing cavity is communicated with the case cavity, and the holding portion protrudes to the case cavity from a portion of an inner surface that defines the case cavity and that is partitioned by the connector-housing cavity;
disposing an electronic circuit section having a connector terminal in the case cavity in such a manner that the electronic circuit section is held by the holding portion; and
filling melting resin into the case cavity and the connector-housing cavity and solidifying the melting resin so as to form a case that seals the electronic circuit section in such a manner that the connector terminal protrudes to an outside of the case and the connector housing that surrounds an outer circumference of the connector terminal.

8. The method according to claim 7, wherein:
the electronic circuit section further includes an electronic element and a wiring member configured to wire the electronic element; and
the connector terminal is electrically coupled with the wiring member.

9. The method according to claim 8, wherein
the wiring member is made of a metal plate and is integrated with the connector terminal.

10. The method according to claim 8, wherein:
the electronic circuit section further includes a sealing member that seals the electronic element;
the sealing member is made of resin and is independent from the case and the connector housing; and
the sealing member is held by the holding portion when the electronic circuit section is disposed in the case cavity.

11. The method according to claim 10, wherein:
the sealing member has a plurality of inserting holes; and
the holding portion includes a plurality of holding elements respectively inserted into the plurality of inserting holes when the sealing member is held by the holding portion.

12. The method according to claim 10, wherein:
the sealing member has a plurality of grooves; and
the holding portion includes a plurality of holding elements respectively engaged with the plurality of grooves when the sealing member is held by the holding portion.
